(19) United States
(12) Patent Application Publication
(10) Pub. No.: US 2017/0019656 A1
(43) Pub. Date: Jan. 19, 2017

(54) AUTOMATIC CALIBRATION SYSTEM AND RELATED AUTOMATIC CALIBRATION METHOD APPLIED TO A CAMERA

(71) Applicant: VIVOTEK INC., New Taipei City (TW)

(72) Inventors: Cheng-Chieh Liu, New Taipei City (TW); Szu-Mo Chang, New Taipei City (TW); Yu-Kang Lin, New Taipei City (TW); Sheng-Yuan Chen, New Taipei City (TW)

(21) Appl. No.: 15/201,516

(22) Filed: Jul. 4, 2016

(30) Foreign Application Priority Data
Jul. 14, 2015 (TW) 104122687

(51) Int. Cl. H04N 13/02

(52) U.S. Cl. CPC H04N 13/0246; H04N 13/0296; H04N 13/0239

(57) ABSTRACT

An automatic calibration system applied to a camera and a related automatic calibration method are disclosed. The automatic calibration method utilizes a motionless calibration plate to calculate a calibration parameter of the camera, the camera includes at least one image sensing unit, and the camera is assembled with a testing device. The automatic calibration method includes rotating the camera by a first shaft and a second shaft of the testing device to change an angle of the at least one image sensing unit of the camera toward the calibration plate, capturing a plurality of images containing the calibration plate by the camera while rotating, calculating the calibration parameter of the camera according to the images, and storing the calibration parameter.

### BACKGROUND OF THE INVENTION

1. Field of the Invention

The present invention relates to a calibration system and calibration method applied to a camera, and more particularly, to an automatic calibration system and a related automatic calibration method capable of automatically executing calibration procedure to increase a calibration speed of the camera and economize testing space for calibration.

2. Description of the Prior Art

One of conventional calibrating methods applied to the camera is manually taking a calibration plate by an operator, moving the calibration plate to different locations before the camera to capture images containing the calibration plate performed by different view angles, and then calculating calibration parameters of the camera according to the images respectively performed by the dissimilar view angles; the said conventional calibrating method is in need of large space where the operator is allowed to hold the calibration plate and move in front of the camera. Another conventional calibrating method is displaying images on the computer screen, and each of the images represents the calibration plate performed in the corresponding view angle, so as to replace the calibrating method by manually moving the calibration plate before the camera; however, accuracy of the conventional calibrating method using the virtual calibration plate is limited to dimensions and resolution of the computer screen, and cannot provide sufficient accuracy as the calibrating method using the real calibration plate.

### SUMMARY OF THE INVENTION

The present invention provides an automatic calibration system and a related automatic calibration method capable of automatically executing calibration procedure to increase a calibration speed of the camera and economize testing space for calibration for solving above drawbacks.

According to the claimed invention, an automatic calibration method capable of utilizing a motionless calibration plate to calculate a calibration parameter of a camera is disclosed. The camera has at least one image sensing unit and is assembled with a testing device. The he automatic calibration method includes utilizing a first shaft and a second shaft different from each other to rotate the camera by the testing device so as to change an angle of the at least one image sensing unit of the camera toward the calibration plate, capturing a plurality of images containing the calibration plate by the camera while the camera is rotated, calculating the calibration parameter of the camera according to the plurality of images, and storing the calibration parameter.

According to the claimed invention, an automatic calibration system capable of calculating a calibration parameter of a camera is disclosed. The camera has at least one image sensing unit. The automatic calibration system includes a calibration plate, at least one testing device, a calculating unit and a storing unit. The calibration plate is disposed on a fixed location in a non-rotatable and non-movable manner. The at least one testing device is disposed by the calibration plate, and a distance between the testing device and the calibration plate is constant. The testing device is applied to support the camera and to rotate the camera by a first shaft and a second shaft different from each other, so as to change an angle of the at least one image sensing unit of the camera toward the calibration plate. The camera captures a plurality of images containing the calibration plate while being rotated by the testing device. The calculating unit is electrically connected to the camera and adapted to calculate the calibration parameter of the camera according to the plurality of images. The storing unit is electrically connected to the camera and adapted to store the calibration parameter.

The present invention disposes the camera on the testing device with biaxial rotation function. The testing device utilizes the first shaft and the second shaft as pivotal axes to change the angle of the image sensing unit of the camera toward the calibration plate. The automatic calibration method in the present invention does not move position of the calibration plate, so that testing space applied to the camera for the automatic calibration procedure can be accordingly economized; because the camera is rotated on the fixed location by the testing device, the camera does not change its location within the testing space, so the testing space can be further economized accordingly for the automatic calibration procedure. The automatic calibration system may utilize preset function of the testing device with the biaxial rotation function to rotate the camera being located at each of the predetermined angles in a programmable controlled manner, and drives the camera to automatically capture the images while being rotated to the predetermined angle, thus the automatic calibration system and the related automatic calibration method of the present invention can simultaneously control the plurality of testing devices via the central control host for execution of the calibration procedure. Comparing to the prior art, the present invention not only economizes the testing space where inside the testing device and the camera are locate, but also successfully increases calibration efficiency of the camera.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an automatic calibration system according to an embodiment of the present invention.

FIG. 2 is a diagram of the automatic calibration system according to another embodiment of the present invention.

FIG. 3 is a diagram of the camera and the calibration plate according to the embodiment of the present invention.

FIG. 4 is a diagram of relative position between the camera and the calibration plate according to the embodiment of the present invention.

FIG. 5 is a flow chart of the automatic calibration method according to the embodiment of the present invention.

FIG. 6 is a diagram of the automatic calibration system according to another embodiment of the present invention.

FIG. 7 is a diagram of the camera and the calibration plate according to another embodiment of the present invention.

FIG. 8a to FIG. 8i respectively are diagrams of images captured by the camera in different angles according to the embodiment of the present invention.

### DETAILED DESCRIPTION

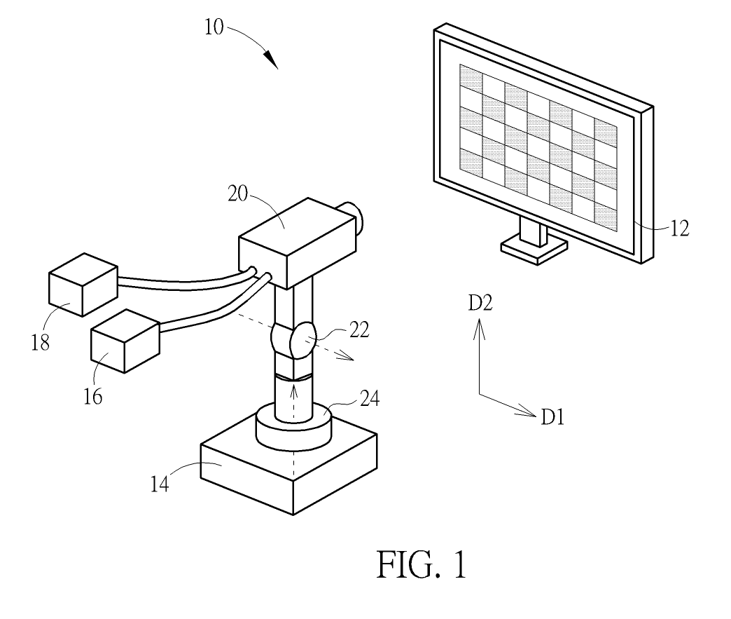

Please refer to FIG. 1. FIG. 1 is a diagram of an automatic calibration system 10 according to an embodiment of the present invention. The automatic calibration system 10 includes a calibration plate 12, a testing device 14, a calculating unit 16 and a storing unit 18. The calibration plate 12 may have, but not be limited to, a chessboard pattern. The chessboard pattern has known dimension and coordinate information and is utilized to acquire data for calculating calibration parameters. The calibration plate 12 is disposed on a fixed location in a non-rotatable and non-movable manner. The testing device 14 is disposed by the calibration plate 12, and a distance between the testing device 14 and the calibration plate 12 is constant. The testing device 14 is utilized to support and rotate the camera 20, and the automatic calibration system 10 can calculate the calibration parameter of the camera through images projected by the chessboard pattern located at different positions within a view range of the camera 20. The calibration parameter may be, but not limited to, a focal length and/or a principal point of the lens, and image distortion resulted by the lens of the camera. As the camera is a stereo camera with multi-lenses, the calibration parameter further can be relative parameters of the multi-lenses, such as relative position in the level direction or relative position in the rotary direction.

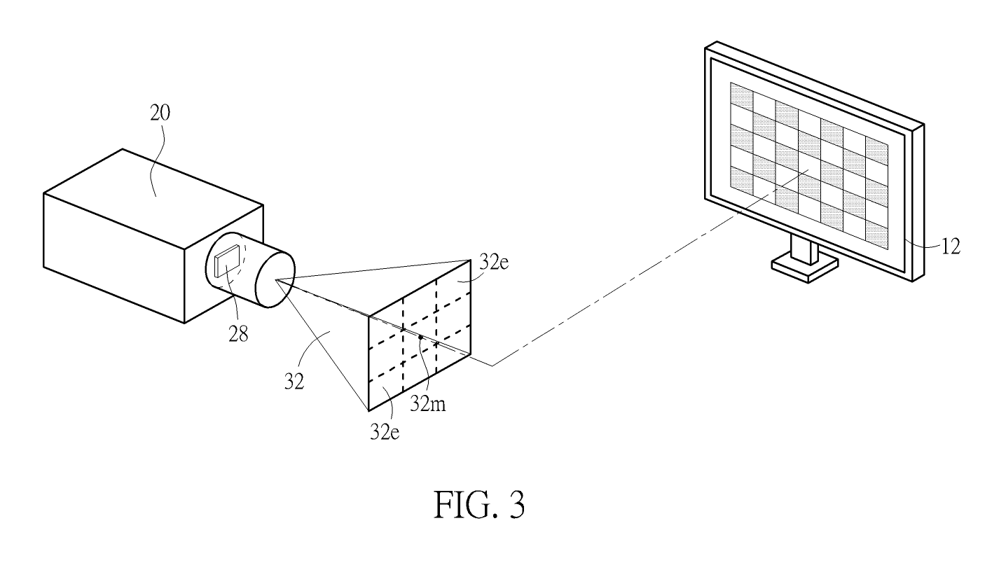

The camera 20 utilizes the calibration parameter to calibrate the image captured by the camera; while the camera is the stereo camera with the multi-lens, the calibrated image further can be applied for depth estimation. The testing device 14 utilizes a first shaft 22 and a second shaft 24 as pivotal axes to rotate the camera 20, so as to change an angle of the at least one image sensing unit 28 (which is shown in FIG. 3) of the camera 20 toward the calibration plate 12.

As shown in FIG. 1, a first direction D1 is substantially perpendicular to a second direction D2. The testing device 14 utilizes the first shaft 22 to rotate the camera 20 and the first direction D1 represents the axial direction of the first shaft 22, for adjusting a tilt angle (which represents the depression angle and the elevation angle) of the camera 20; the testing device 14 further utilizes the second shaft 24 to rotate the camera 20 and the second direction D2 represents the axial direction of the second shaft 24, for adjusting the lateral rotary angle of the camera 20. While the camera 20 is rotated via the first shaft 22 and the second shaft 24, the camera 20 can automatically or manually capture the plurality of images containing the calibration plate 12, and the plurality of images respectively shows patterns of the calibration plate 12 with different vision angles. The calculating unit 16 and the storing unit 18 selectively can be independent of the camera 20 or be the built-in elements inside the camera 20, which depends on design demand. The calculating unit 16 may compare the known coordinate points on the calibration plate with projecting points captured by the camera to calculate the calibration parameter of the camera 20 according to conventional algorithm, such as technical report “A Flexible New Technique for Camera Calibration” from Microsoft Research. The calibration parameter is stored by the storing unit 18 for later calibration applied to the image captured by the camera 20.

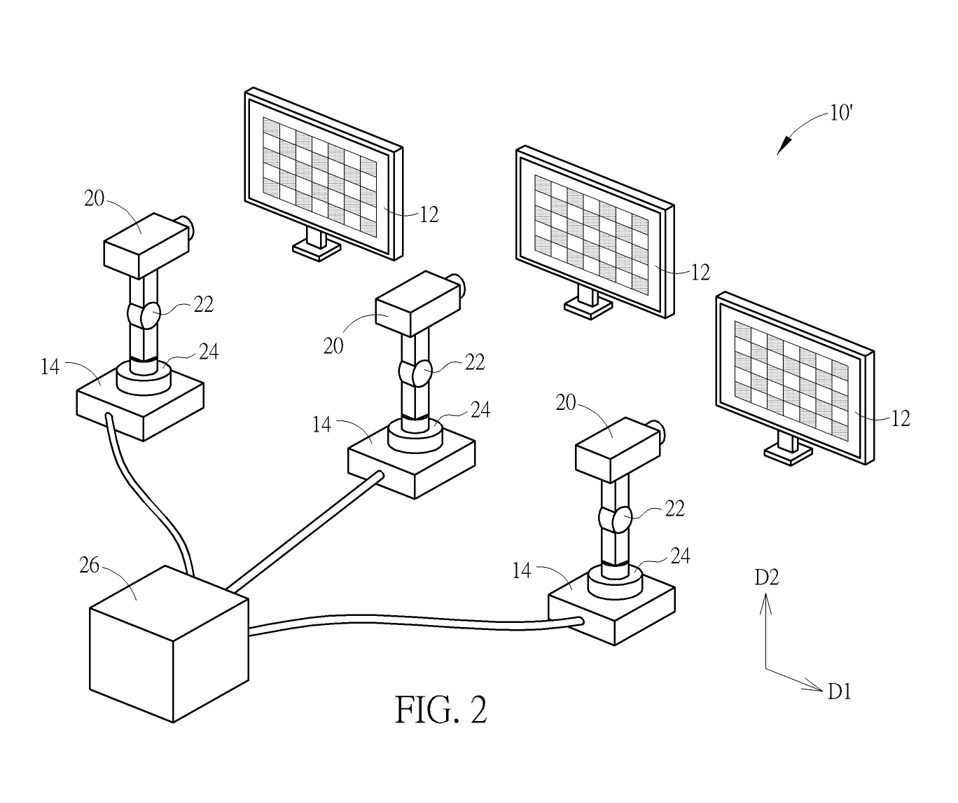

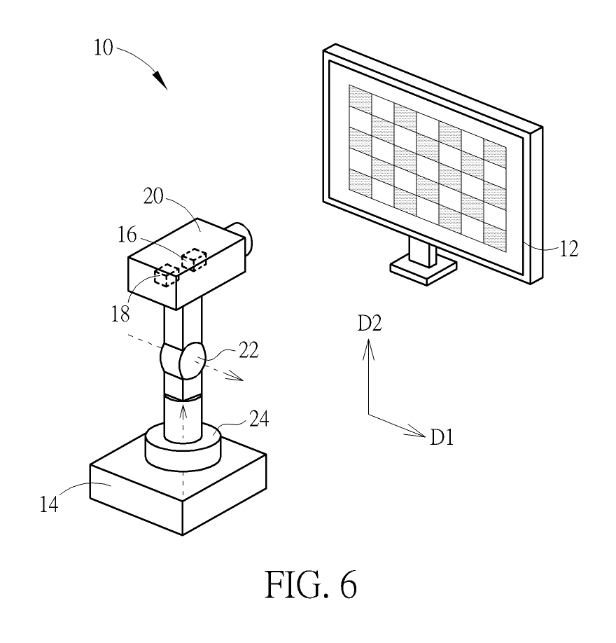

Please refer to FIG. 2. FIG. 2 is a diagram of the automatic calibration system 10′according to another embodiment of the present invention. The automatic calibration system 10′ includes several testing devices 14 and a central control host 26. The central control host 26 is electrically connected to all the testing devices 14, and each of the testing devices 14 has a corresponding calibration plate 12. The automatic calibration system 10′ shown in FIG. 2 has three testing devices 14 and three calibration plates 12, which can be varied by actual demand. The central control host 26 may include the calculating unit 16 and the storing unit 18. As the above-mentioned embodiments, the calculating unit 16 and the storing unit 18 are selectively independent of the camera 20 (such as the embodiment shown in FIG. 1) or are the built-in elements inside the camera 20 (such as the embodiment shown in FIG. 6). The central control host 26 can control the depression angle, the elevation angle and the lateral rotary angle of the testing devices 14 according to a predetermined procedure (such like the predetermined automatic calibration procedure of the camera 20), so as to respectively calculate the calibration parameter of the camera 20 corresponding to each of the testing devices 14.

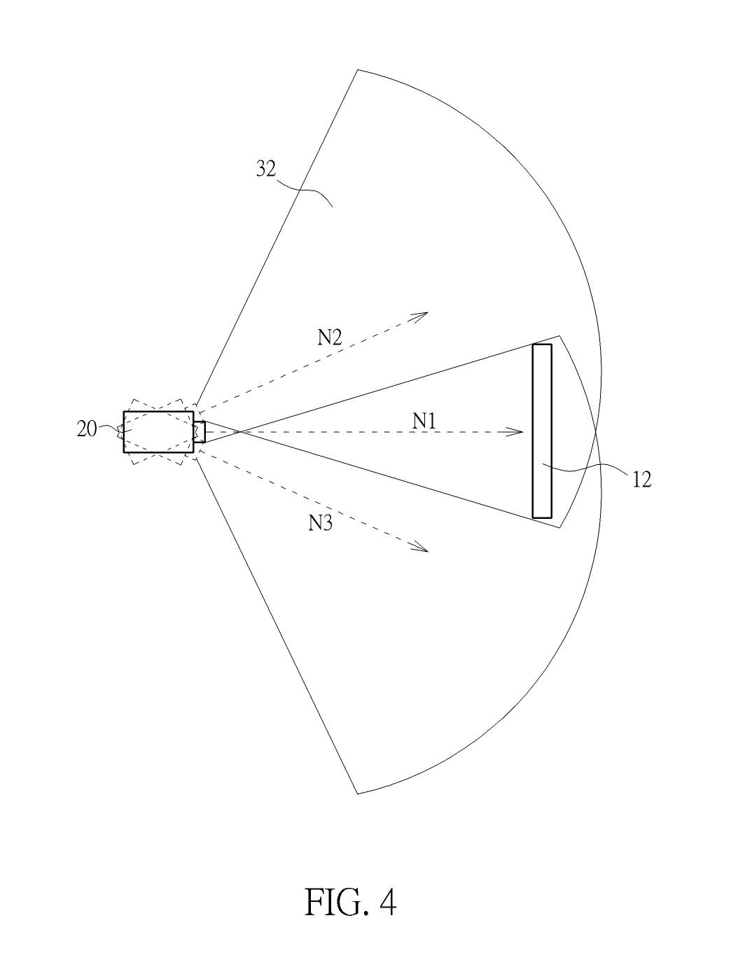

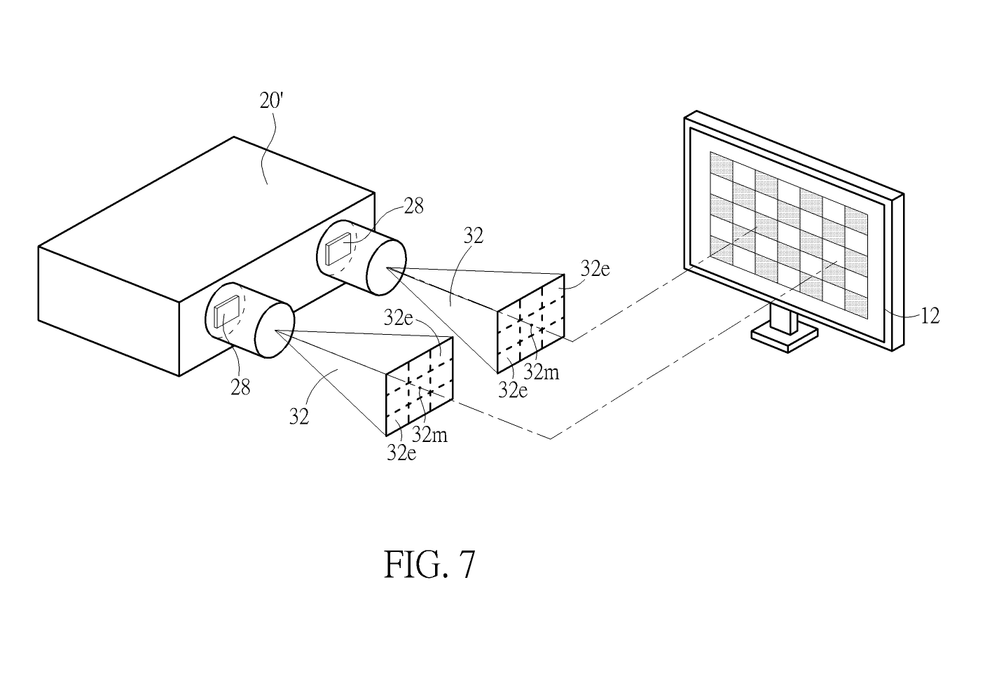

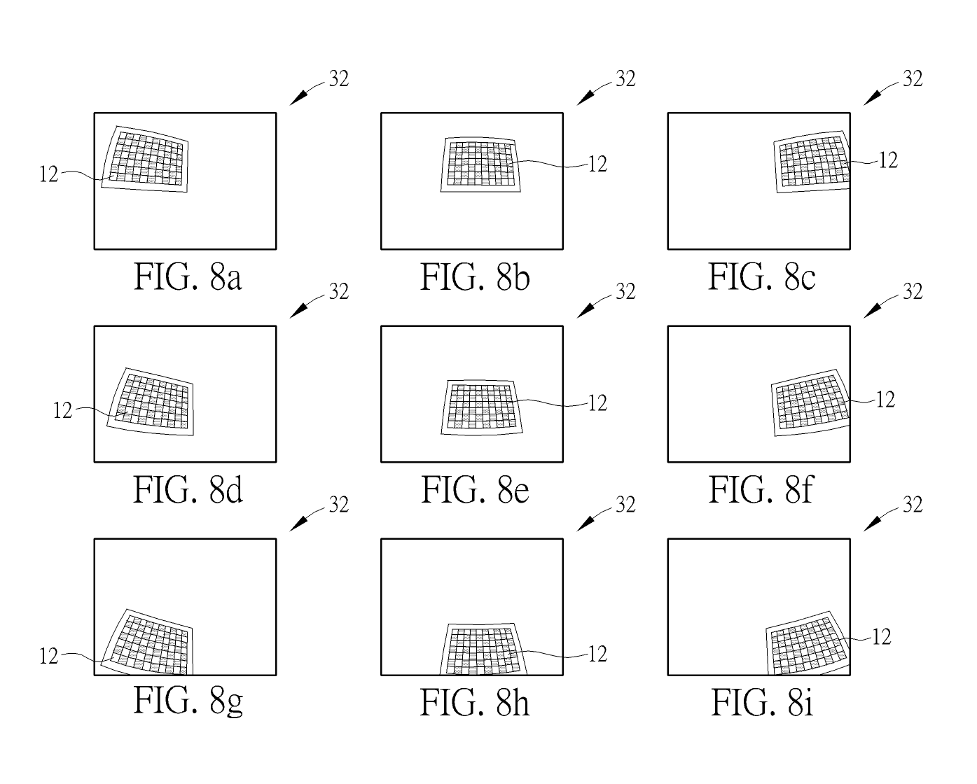

Please refer to FIG. 3, FIG. 4 and FIG. 7. FIG. 3 is a diagram of the camera 20 and the calibration plate 12 according to the embodiment of the present invention. FIG. 4 is a diagram of relative position between the camera 20 and the calibration plate 12 according to the embodiment of the present invention. FIG. 7 is a diagram of the camera 20′ and the calibration plate 12 according to another embodiment of the present invention. As shown in FIG. 7, the camera 20′ is a dual-lenses camera for capturing the stereo image. Each lens of the camera 20′ has an image sensing unit 28. As shown in FIG. 3, at least one image sensing unit 28 is disposed inside the camera 20, and the at least one image sensing unit 28 preferably can be a rectangle form (or any other form). The testing device 14 rotates the camera 20 by the first shaft 22 and the second shaft 24 to change the angle of the image sensing unit 28 toward the calibration plate 12. Moreover, a view angle 32 of the camera 20 can be at least divided into nine regions. The testing device 14 rotates the camera 20 by the first shaft 22 and the second shaft 24 to sequentially align a middle region 32m and two edged region 32e of the view angle 32 with the calibration plate 12, and the camera 20 captures the images containing the calibration plate 12 accordingly. As shown in FIG. 8a to FIG. 8i, position and vision angles of the calibration plate 12 relative to the image sensing unit 28 within the images are different from each other, inclination of the chessboard pattern on the images are varied, and information acquired from the images containing different chessboard pattern are dissimilar accordingly. The calculating unit 16 utilizes the information acquired from the images, and the known dimension and coordinate information of the chessboard pattern to calculate the calibration parameter of the camera 20. In addition, computation of the calibration parameter of the camera 20′ is the same as the foresaid embodiment, and a detailed description is omitted herein for simplicity.

It should be mentioned that the view range 32 of the camera 20 can be selectively divided into several uniform or various regions, an amount of the regions is not limited to the embodiment shown in FIG. 3. The camera 20 preferably captures the images while the calibration plate 12 aligns with the middle region 32m and any two edged regions 32e of the view range 32, the two edged regions 32e mentioned as above are not limited to the position shown in the FIG. 3, and any two of the all edged regions 32e can be utilized according to actual demand or design practice of the user.

As shown in FIG. 4, while the camera 20 is rotated from the first capturing direction N1 to the second capturing direction N2, the view range 32 (such as a cone form shown in the figure) moves upward, the calibration plate 12 is motionless and aligned with the lower region (such like the lower edged region 32e shown in FIG. 3) of the view range 32; while the camera 20 is rotated from the first capturing direction N1 to the third capturing direction N3, the view range 32 moves downward, the calibration plate 12 is motionless and aligned with the upper region (such like the upper edged region 32e shown in FIG. 3) of the view range 32. That is to say, the testing device 14 is utilized to adjust the angle of the camera 20 relative to the calibration plate 12, so as to change the angle of the image sensing unit 28 toward the calibration plate 12, and the images are captured accordingly while the image sensing unit 28 and the calibration plate 12 are in a non-coplanar mode for calculation of the calibration parameter. The camera 20 shown in FIG. 4 is revolved on the shaft axes of the testing device 14 to change the depression angle and the elevation angle of the image sensing unit 28 toward the calibration plate 12, and actual values of the depression and elevation angle are not limited the embodiment shown in the figure, which depends on design demand. Besides, the lateral rotary angle of the camera 20 relative to the calibration plate 12 is adjusted by the same operation as adjustment of the depression and elevation angle of the testing device 14 shown in FIG. 4, and a detailed description is omitted herein for simplicity.

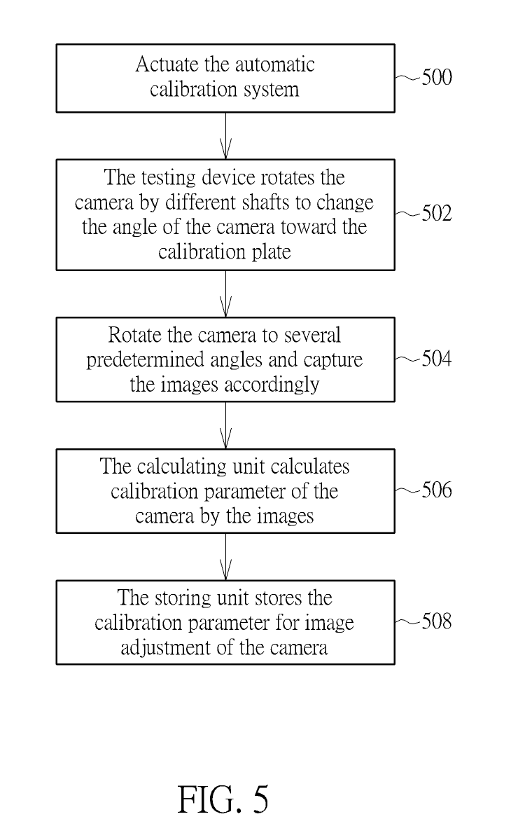

Please refer to FIG. 5. FIG. 5 is a flowchart of the automatic calibration method according to the embodiment of the present invention. The automatic calibration method illustrated in FIG. 5 is suitable for the automatic calibration system 10, 10′ shown in FIG. 1 and FIG. 2. First, step 500 is executed to actuate an automatic calibration function of the automatic calibration system 10, 10′. Then, step 502 is executed to rotate the camera 20 by the first shaft 22 and the second shaft 24 of the testing device 14, so as to change the angle of the at least one image sensing unit 28 of the camera 20 toward the calibration plate 12. While step 504 is executed, the testing device 14 rotates the camera 20 sequentially to several predetermined angles, and captures the images corresponding to different vision angles since the camera 20 is rested on the each predetermined angle. For example, the camera 20 is rotated from an initial position to the first predetermined angle to stay and capture the 1^{st} image of the plurality of images, and then rotated from the first predetermined angle to the second predetermined angle to stay and capture the 2^{nd} image of the said images, and further rotated from the second predetermined angle to the third predetermined angle point to stay and capture the 3^{rd} image of the said images. Final, steps 506 and 508 are executed that the calculating unit 16 calculates the calibration parameter of the camera 20 according to the captured images, and the storing unit 18 stores the foresaid calibration parameter for later image adjustment of the camera 20.

During execution of step 504, the first predetermined angle, the second predetermined angle and the third predetermined angle respectively can be represented as, but not limited to, the first capturing direction N1, the second capturing direction N2 and the third capturing direction N3 shown in FIG. 4. The camera 20 does not capture the image while being rotated between the said predetermined angles; the testing device 14 does not rotate the camera 20 while the camera 20 captures the images at each of the predetermined angles, and the camera 20 can actuate the image capturing function automatically or manually according to user's demand.

In conclusion, the present invention disposes the camera 20 on the testing device 14 with biaxial rotation function. The testing device 14 utilizes the first shaft 22 and the second shaft 24 as pivotal axes to change the angle of the image sensing unit 28 of the camera 20 toward the calibration plate 12. The automatic calibration method in the present invention does not move position of the calibration plate 12, so that testing space applied to the camera 20 for the automatic calibration procedure can be accordingly economized; because the camera 20 is rotated on the fixed location by the testing device 14, the camera 20 does not change its location within the testing space, so the testing space can be further economized accordingly for the automatic calibration procedure. The automatic calibration system 10 may utilize preset function of the testing device 14 with the biaxial rotation function to rotate the camera 20 being located at each of the predetermined angles in a programmable controlled manner, and drives the camera 20 to automatically capture the images while being rotated to the predetermined angle, thus the automatic calibration system 10 and the related automatic calibration method of the present invention can simultaneously control the plurality of testing devices 14 via the central control host 26 for execution of the calibration procedure. Comparing to the prior art, the present invention not only economizes the testing space where inside the testing device and the camera are locate, but also successfully increases calibration efficiency of the camera 20.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An automatic calibration method capable of utilizing a motionless calibration plate to calculate a calibration parameter of a camera, the camera having at least one image sensing unit and being assembled with a testing device, the automatic calibration method comprising:
the testing device utilizing a first shaft and a second shaft different from each other to rotate the camera, so as to change an angle of the at least one image sensing unit of the camera toward the calibration plate;
the camera capturing a plurality of images containing the calibration plate while being rotated by the testing device;
calculating the calibration parameter of the camera according to the plurality of images; and
storing the calibration parameter.

2. The automatic calibration method of claim 1, wherein the testing device changes the angle of the at least one image sensing unit toward the calibration plate, and captures the plurality of images while the at least one image sensing unit and the calibration plate are in a non-coplanar mode.

3. The automatic calibration method of claim 1, wherein the testing device rotates the camera by the first shaft and the second shaft, to change a tilt angle of the at least one image sensing unit vertically toward the calibration plate and a rotary angle of the at least one image sensing unit laterally toward the calibration plate.

4. The automatic calibration method of claim 3, wherein the testing device rotates the camera to a predetermined specific angle by the first shaft and the second shaft, and the camera captures the plurality of images while the camera is set on the predetermined specific angle.

5. The automatic calibration method of claim 1, further comprising:
dividing a view range of the camera into nine regions; and
rotating the camera to respectively capture the plurality of images while the calibration plate is aligned with a middle region and two edged regions of the nine regions.

6. The automatic calibration method of claim 1, wherein the camera is a stereo camera having a plurality of image sensing units.

7. An automatic calibration system capable of calculating a calibration parameter of a camera, the camera having at least one image sensing unit, the automatic calibration system comprising:
a calibration plate disposed on a fixed location in a non-rotatable and non-movable manner;
at least one testing device disposed by the calibration plate, a distance between the testing device and the calibration plate being constant, the testing device being applied to support the camera and to rotate the camera by a first shaft and a second shaft different from each other, so as to change an angle of the at least one image sensing unit of the camera toward the calibration plate, wherein the camera captures a plurality of images containing the calibration plate while being rotated by the testing device;
a calculating unit electrically connected to the camera and adapted to calculate the calibration parameter of the camera according to the plurality of images; and
a storing unit electrically connected to the camera and adapted to store the calibration parameter.

8. The automatic calibration system of claim 7, wherein the testing device changes the angle of the at least one image sensing unit toward the calibration plate, and captures the plurality of images while the at least one image sensing unit and the calibration plate are in a non-coplanar mode.

9. The automatic calibration system of claim 7, wherein the testing device rotates the camera by the first shaft and the second shaft, to change a tilt angle of the at least one image sensing unit vertically toward the calibration plate and a rotary angle of the at least one image sensing unit laterally toward the calibration plate.

10. The automatic calibration system of claim 9, wherein the testing device rotates the camera to a predetermined specific angle by the first shaft and the second shaft, and the camera captures the plurality of images while the camera is set on the predetermined specific angle.

11. The automatic calibration system of claim 7, wherein a view range of the camera is at least divided into nine regions, the testing device rotates the camera by the first shaft and the second shaft, and the camera respectively captures the plurality of images while the calibration plate is aligned with a middle region and two edged regions of the nine regions.

12. The automatic calibration system of claim 7, wherein the automatic calibration system further comprises a plurality of testing devices and a central control host, the central control host comprises the calculating unit and the storing unit and is electrically connected to the plurality of testing devices, the central control host controls rotation of the plurality of testing devices according to a predetermined procedure to respectively calculate the calibration parameter of the camera corresponding to each of the plurality of testing devices.

13. The automatic calibration system of claim 7, wherein the camera is a stereo camera having a plurality of image sensing units.
